(19) United States
(12) Patent Application Publication
(10) Pub. No.: US 2002/0198830 A1
(43) Pub. Date: Dec. 26, 2002

(54) Method and system for handling disputes in an electronic invoice management system

(76) Inventors: Wayne L. Randell, Oakville (CA); Leonard A. Podgurny, Mississauge (CA); Edward A. Widlake, Grimsby (CA)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/846,924

(22) Filed: May 1, 2001

(51) Int. Cl. G06F 17/60

(52) U.S. Cl. 705/40

(57) ABSTRACT

A method and system for managing invoices offering dispute handling capabilities is provided. The electronic invoice management system includes a biller machine and a customer computing unit interconnected by a data network. The biller machine includes an invoice generation unit and a dispute resolution unit. The dispute resolution unit is linked to a dispute history data structure holding a plurality of groups of records, each group being associated to a corresponding customer entity. Each record includes reasons a prior invoice produced by the invoice generation unit was disputed by a customer entity. The dispute resolution unit is responsive to a message received from the customer computing unit over the data network and representative of reasons to dispute a new invoice to locate the group of records corresponding to the given customer entity associated to the customer computing unit. A record is created from the message and then stored in the dispute history data structure for future use.

### FIELD OF THE INVENTION

This invention relates to a system and method for facilitating online commerce over a public network such as the Internet or an interactive T.V. cable network. More particularly, this invention relates to a system and method providing an electronic invoice management system having dispute handling capabilities.

### BACKGROUND OF THE INVENTION

Online commerce has experienced dramatic growth in recent years and this growth is expected to continue into the coming decades. Internet service providers are, more and more, connecting users to the Internet at no cost, thus eliminating barriers to an Internet connection. At the same time, merchants are increasingly developing sites on the World Wide Web (or simply “WWW” or “Web”) that customers can access to order goods and/or services. It is now fairly common for a customer to browse a merchant's catalogue, select a product or service and place an order for the product/service all electronically over the Internet. Similarly, it is becoming increasingly common for merchants to allow payment of invoices electronically. Typically, the invoice is sent electronically to the customer via electronic mail or made available to the customer over a network by providing the customer with network access capability.

A deficiency with many electronic payment systems is that they are ill suited to certain business-to-business environments. In typical business environments, it is common for the customer to occasionally question items on an invoice or to otherwise dispute an amount on an invoice. Typically, when the customer wants to dispute an item on an invoice, he contacts the biller via telephone and explains the problem to a representative at the biller site. An agreement is sometimes reached and the dispute is resolved or the representative at the biller site takes down the complaint from the customer for the purpose of contacting the customer at a future time regarding the dispute. This process is time consuming and costly from both the customer's perspective, who must tie up resources over the telephone, and from the biller's perspective, who must provide a representative for handling disputes. Furthermore, this process often results in delays in the payment of an invoice.

A solution to the above problem is to provide the customer with the ability to submit a dispute for an invoice electronically along with payment remittance information. U.S. Pat. No. 6,070,150, issued to Remington et al. on May 30, 2000, describes an electronic payment system that provides the customer with the ability to dispute an item in an invoice by “marking” an item in a predefined list of dispute reasons, or by typing a detailed reason for the dispute in a dialog box. The information supplied by the customer is included along with the payment remittance information associated with the invoice. The contents of U.S. Pat. No. 6,070,150 are incorporated herein by reference.

A deficiency with systems of the type described above is that they do not provide the representative at the biller with a view of the relationship between the biller and the customer. A representative at the biller entity still must contact the customer to resolve the dispute. The situation is aggravated in large business environments where there are many customers and/or many representatives taking care of disputes. For example, if a customer is disputing an item on a current bill that is similar to a disputed item on a previous bill, the customer is frequently required to re-iterate all the details to the representative of the biller. This is time consuming and aggravating for the customer and may potentially damage the relationship that the biller has with that customer.

Consequently there exists a need in the industry to provide an improved system and method for processing invoices that alleviates at least in part the deficiencies of prior art systems and methods.

### SUMMARY

In accordance with a broad aspect, the invention provides a method for electronic invoice management comprising generating at a biller machine data files representative of invoices issued by a biller to respective customer entities. A data structure holding a plurality of groups of records is provided, where each group of records is associated to a corresponding customer entity. Each record is descriptive of reasons a prior invoice generated at the biller machine was disputed by a customer entity. In response to a message to the biller machine issued by a customer computing unit, where the message is representative of reasons submitted by a given customer entity to dispute an invoice, the group of records corresponding to the given customer entity is located in the data structure. A record is created on the basis of the message representative of reasons to dispute an invoice from the given customer entity. The created record is then stored in the dispute history data structure.

An advantage of the present invention is that it allows the biller to be provided with a dispute history allowing him to detect repetitive issue problems. The information stored in the dispute resolution data structure provides the biller with an indication as to what procedures should be put into place to reduce or eliminate the source of recurring disputes such as to improve the quality of the service offered to the customer entities.

In accordance with a specific implementation, a message is issued to the customer computing unit to cause the generation at the customer computing unit of a dispute resolution interface. The dispute resolution interface has a plurality of predetermined choices that an operator at the customer computing unit can select, each choice being a predetermined reason to dispute an invoice. The dispute resolution interface may also be provided with an editable field in which the operator at the customer computing unit can enter a text message.

A message can also be issued to a biller computing unit to cause the generation at the biller computing unit of a biller dispute resolution interface, where the biller computing unit is associated to an operator. The biller dispute resolution interface includes a field for displaying information about the new invoice disputed by the given customer entity. The biller dispute resolution interface includes a field linked to said dispute history data structure to display the group of records associated with the given customer entity.

An advantage of the present invention is that it allows the biller to readily be provided with a view of his relationship with his customer without requiring the customer to re-iterate past issues. This is particularly advantageous as it allows the accounts receivable department at a biller site to adapt it response to a current dispute according to the previous disputes with that customer. For example, if a customer has previously disputed recurring items, such as taxes, which he is not required to pay, the system allows to immediately view the situation with requiring the customer to re-iterate explanations.

Another advantage of the present invention is that it provides the biller with the ability to more readily detect abuses made by a given customer entity relative to invoices. For example, if a given customer entity consistently complains that an invoice is too high because he was unaware of certain fees charged by the biller, the biller may decide to be less responsive to that customer entity indicating that the fees were clearly set out in documentation provided.

In accordance with a non-limiting example, the biller dispute resolution interface includes a filter to perform a filtering function on the group of records associated with the given customer entity. The filter is modifiable for allowing an operator at the biller computing unit to specify a filtering function. The filtering function allows the display of only the records in the group of records associated with the given customer entity that match the filtering function.

The biller dispute resolution interface includes an editable field in which the operator at the biller computing unit can enter a text string. The text string entered at the biller computing unit is stored in the dispute history data structure in association with the record corresponding to the new invoice.

The text string stored in association with the record is accessible by the customer computing unit for display on the dispute resolution interface. More specifically, a message is issued to a customer computing unit to cause the generation at the customer computing unit of a dispute resolution interface. The dispute resolution interface includes a first field displaying information about the new invoice disputed by the given customer entity and a second field displaying information indicative of the text string entered at the biller computing unit.

Advantageously, this allows establishing a dialogue between the biller and the customer, thereby allowing the biller to provide the result of an investigation on a disputed invoice directly to the customer entity without telephone interaction.

In accordance with a specific implementation, the dispute history for a given customer is accessed by the biller when issuing a new invoice or handling new disputes.

Advantageously, this allows a reduction in the reoccurrence of errors as well as improves the rate at which invoice disputes are handled.

In accordance with another broad aspect, the invention provides a computer readable medium including a program element executable by a computing apparatus for implementing the above described method.

In accordance with a broad aspect, the invention provides a system implementing the above-described method.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a block diagram of an electronic invoice management system having dispute handling capabilities in accordance with an embodiment of the invention, including a biller computing system 116, a network 106, and a customer computing system 150 having a plurality of computing units;

FIG. 2a is a block diagram depicting one of the customer computing units shown in FIG. 1 in accordance with an embodiment of the invention;

FIG. 2b is a block diagram depicting the biller computing system 116 shown in FIG. 1 in accordance with an embodiment of the invention;

FIG. 3 is a flow diagram of a registration phase for use in connection with a process for electronically presenting and granting payment of invoices in accordance with an example of implementation of the invention;

FIG. 4 is a flow diagram of the process for handling a dispute associated to an invoice in accordance with a specific example of implementation of the invention;

FIG. 5a and 5b is a non-limiting example of implementation of a graphical user interface for presenting a plurality of unpaid invoices associated to a customer entity;

FIG. 6a and 6b is a non-limiting example of implementation of a dispute resolution interface where the operator at a customer computing unit has entered reasons to dispute an invoice;

FIG. 7a and 7b is a non-limiting example of implementation of a biller dispute resolution interface where the operator at a biller computing unit has entered a response to the reasons to dispute an invoice.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

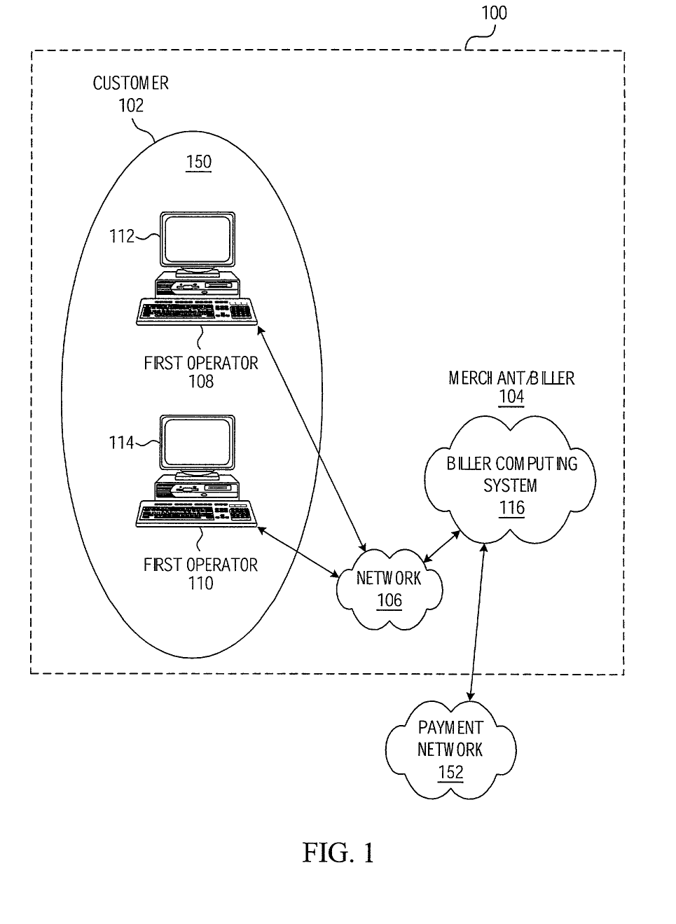

FIG. 1 shows an electronic invoice management system 100 providing dispute handling capabilities in accordance with a specific implementation. The system 100 allows a customer entity 102 to view the state of its accounts payable with regards to a specific biller 104 and to issue payment instructions to that specific biller 104. The system 100 also allows the specific biller 104 to receive information regarding dispute information associated to a certain invoice. The system 100 includes a biller computing system 116 and a customer computing system 150 interconnected through a network 106. The biller computing system 116 and the customer computing system 150 include tools for facilitating online commerce transactions between the customer entity 102 and the biller entity 104.

The network 106 is a data communication network interconnecting the customer computing system 150 and the biller computing system 116. In a specific example of implementation, the network is a public network. In the illustrated implementation, the data communication network 106 is embodied in the Internet. It is to be noted that the data communication network 106 may be implemented as a network other that the Internet such as an interactive television (ITV) network, a private network such as an Intranet or any other suitable network.

The customer computing system 150 comprises a plurality of computing units 112 114, each associated to a respective operator 108, 110. The computing units 112 114 are generally in the form of personal computers, although other types of computing units may be used including laptops, notebooks, hand-held computers, set top boxes, and the likes. The plurality of computing units 112 114 may be connected to one another over an Intranet or may be stand-alone computing units. Each of the computing units 112 114 is provided with a connection to the network 106. The connection may be a permanent connection through a server at the customer's premises, or alternatively, a given computing unit may occasionally connect to the network 106 through the use of a dial-up connection using a suitable device such as a modem for example. For the purpose of simplicity, the example described herein below considers a customer computing system 150 including two customer computing units 112 114 each being respectively associated to a first operator 108 and a second operator 110. It will be readily appreciated that a customer computing system 150 including in excess of two customer-computing units remains within the invention.

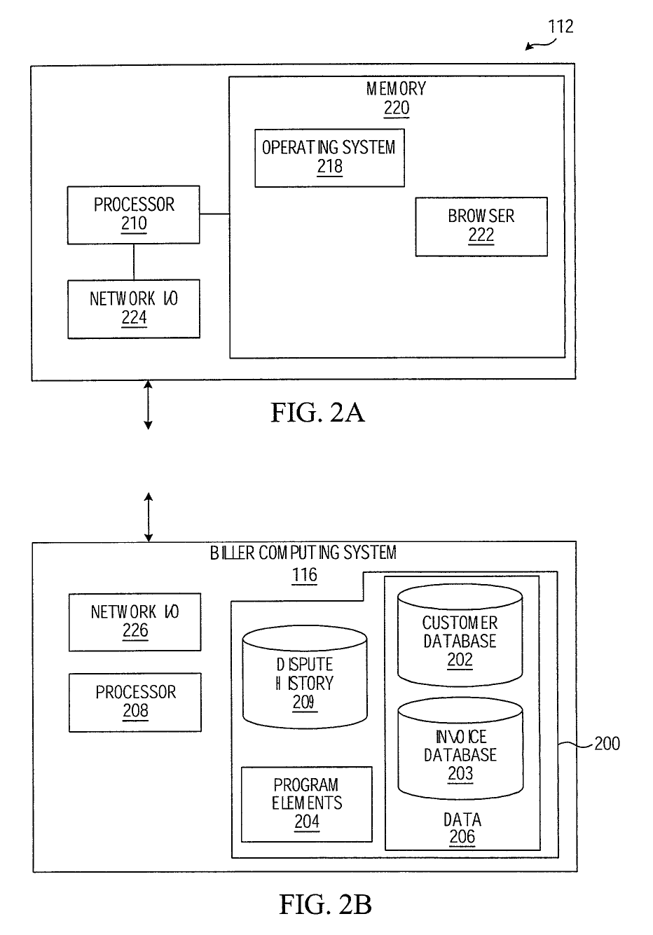

FIG. 2a depicts a block diagram of customer computing unit 112. The structure and functionality of customer computing unit 114 is identical to that of customer computing unit 112 and as such will not be described. As shown, the customer computing unit 112 comprises a processor 210, a memory 220 and a network I/O 224 (input/output) for accessing the network 106. The network I/O 224 can be implemented, for example, as a dial-up modem or as a permanent network connection. The processor 210 is adapted to execute program elements stored in the memory 220 for performing certain functions. More specifically, the customer computing unit 112 runs an operating system 218 that supports multiple applications. The operating system 218 is preferably a multitasking operating system that allows simultaneous execution of multiple applications in a graphical windowing environment. The memory 220 also includes a browser program element 222. The browser program element 222 when launched is executed by the processor 210 atop the operating system 218. The customer computer unit 112 may also include e-mail software components (not shown) as well as additional components and modules. These have been omitted from the description for the purpose of clarity.

The biller computing system 116 includes one or more computer servers and one or more computing apparatuses. The system includes program elements allowing the biller entity 104 to manage customer invoices and to provide electronic processing of invoices. The biller computing system 116 may also include modules for connection to a payment network 152 (shown in FIG. 1). The payment network 152 represents existing networks that presently accommodate transactions for credit cards, debit cards, checks and other types of financial payment processes. A description of the payment network 152 and of the interaction of the biller computing system 116 with the payment network 152 is not necessary for the understanding of the present invention and as such will not be described.

FIG. 2b shows a block diagram depicting a schematic diagram of the biller computing system 116. As depicted, the biller computing system 116 comprises a processor 208, a memory 200 and a network I/O 226 (input/output) for connection to the network 106. The network I/O 226 is preferably implemented as a permanent network connection although dial up connections may be suitable in certain embodiments. For example, if the biller computing system 116 interacts with the customer computing system 150 via e-mail, then a dial-up connection may be suitable.

The processor 208 is adapted to execute program elements 204 stored in the memory 200 for performing various functions. Amongst others, the program elements include modules suitable from implementing an invoice generation unit for producing data files representative of invoices issued by the biller to respective customer entities. The program elements also include modules for implementing a dispute resolution unit for providing dispute resolution capabilities to the electronic invoice management system. The program elements may also include modules suitable from implementing a customer registration unit. The memory 200 also has a data portion 206 including a customer database 202, a dispute history data structure 209 and an invoice database 203. The program elements 204 operate on the data 206 in accordance with the methods that will be described below. It will be readily appreciated that the biller computing system 116 may include additional components and modules. These have been omitted from the description for the purpose of clarity.

The dispute history data structure 209 includes information pertaining to past disputes between the customers of the biller and the biller. The dispute history data structure 209 stores information which allows the biller to have a more complete view of his relationship with his customer without requiring the customer to re-iterate past issues.

In a non-limiting implementation, the dispute history data structure holds a plurality of groups of records, each record being descriptive of reasons a prior invoice produced by the biller was disputed by a customer entity. Each group of records is associated to a corresponding customer entity. Each record is comprised of a plurality of fields describing various aspects of the associated dispute. In a non-limiting example, each record includes a user name field, an invoice number field, a dispute date field, a dispute description field, a dispute stage field and a resolution details/notes field. The user name field stores an identifier associated to the operator at the customer site having submitted the dispute, the dispute date field stores the date the dispute was submitted and the invoice number field stores an identification of the invoice to which the disputes is associated. The dispute description field stores a description of the dispute reasons submitted by the customer. The resolution details/notes field stores notes as well as the resolution information of the dispute as provided by an operator at the biller. The dispute stage field is indicative of the stage of the dispute such as dispute initiated, dispute resolved, dispute suspended and so on.

The table below is a representation of an entry in the dispute history data structure 209 for customer DEF INC. As shown, DEF INC. has six (6) records. Each record includes the notes and resolution details associated to each dispute. Disputes that have been resolved include the words “done” in the dispute stage field. The second record includes the word “init” indicating that the dispute trigger event has been initiated but that the biller has not addressed the dispute.

Customer DEF Inc. : Dispute History

| User | | Invoice | Dispute | Resolution | |
|---|---|---|---|---|---|
| name | Date | Number | Detail | Details | Stage |
| User2 | Feb. 2, 2001 | 498352P | 10% discount | 1. Investigating | Done |
| | | | negotiated | with | |
| | | | with | M. Smith | |
| | | | M. Smith | 2. 10% discount | |
| | | | is not | confirmed by | |
| | | | reflected | M. Smith. | |
| | | | | Invoice | |
| | | | | corrected | |
| User1 | Jan. 2, 2001 | 487625P | Incorrect | | Init |
| | | | hourly | | |
| | | | billing rate | | |
| | | | applied | | |
| User1 | Nov 12, 2000 | 453412P | Incorrect | 1. Rate has | Done |
| | | | hourly | been corrected | |
| | | | billing rate | and invoice re- | |
| | | | applied | issued with | |
| | | | | correct billing | |
| | | | | rate | |
| User2 | Oct. 11, 2000 | 35236P | Incorrect | 1. Invoice | Done |
| | | | currency. | corrected to | |
| | | | Invoice | reflect correct | |
| | | | should be in | currency | |
| | | | U.S. Dollars | | |
| User1 | Sep. 9, 2000 | 28836P | Incorrect | 1. Invoice | Done |
| | | | currency. | corrected to | |
| | | | Invoice | reflect correct | |
| | | | should be in | currency | |
| | | | U.S. Dollars | | |
| User1 | May 9, 2000 | 26836P | Incorrect | 1. Invoice | Done |
| | | | currency. | corrected to | |
| | | | Invoice | reflect correct | |
| | | | should be in | currency | |
| | | | U.S. Dollars | | |

It is to be expressly understood that other formats for a dispute history data structure 209 are possible without detracting from the spirit of the invention.

The customer database 202 includes information pertaining to the customers of the biller entity. This information is provided by the customer entity 102 to the biller 104 via a registration process. In a non-limiting implementation, for each customer entity, an entry is provided including various information data elements associated to the customer entity. Amongst others, each entry includes a plurality of records, each record including a user identifier with a corresponding password.

The invoice database 203 includes for each customer in the customer database 202 a list of invoice entries associated to invoices that are not fully paid. Each invoice entry includes an invoice identifier, an invoice amount, an unpaid amount and a dispute status data element identifying whether the invoice is the subject of a dispute event. The dispute status data element is indicative of either one of the presence of a dispute event associated to the invoice and the absence of a dispute event associated with the invoice. In addition, each invoice may include a pointer associating the corresponding invoice to an entry in the dispute history data structure. Other data elements may also be present without detracting from the spirit of the invention.

The memory also includes a program element 204 for operating on the data 206 for managing invoices and to provide dispute handling capabilities for facilitating dispute resolutions associated to an invoice.

A typical interaction will better illustrate the functioning of the electronic invoice management system 100 providing dispute handling capabilities and of program elements 204. The program elements 204 implement the functionality of the electronic invoice management system 100 including a customer registration module, an invoice generation unit and a dispute resolution unit.

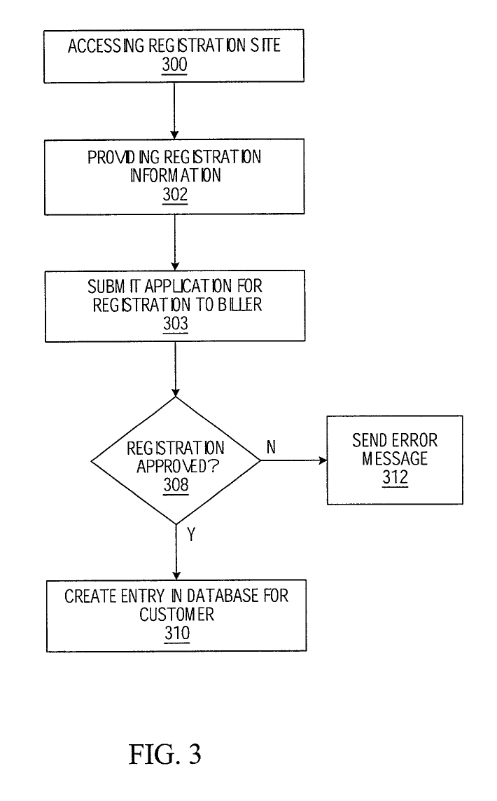

Prior to the use of the electronic invoice management system 100, the customer entity 102 registers with the biller entity 104. The registration between the customer entity and the biller entity may be effected over the network 106 or by providing a form to be transmitted by mail, fax or other suitable transmission methods. Registration over the network 106 through a web-based interface will be described herein below with reference to FIG. 3 of the drawings. Registration through the other methods will be readily apparent to the reader skilled in the art. The customer registration unit implemented by the program elements 204 facilitates the registration process over the network 106. At step 300, an operator at the customer site accesses a designated registration website associated with the biller through a network link by providing a network address. This action submits a request for registration of a new customer with the biller entity 104. In response, the customer entity system downloads a registration unit implemented by program element 204 (shown in FIG. 2) from the biller computing system 116 to a customer computing unit. The registration unit automatically launches to aid the operator at the customer site in the completion of the online application for registration. In a specific example of implementation, the registration unit is configured to provide step-by-step instructions. At step 302, the operator at the customer site fills out a form including various fields related to personal and financial matters, such as company name, address, telephone number, credit card numbers, bank affiliations, and the likes. The operator also provides data related to preferred payment methods as well as a list of authorized user identifiers and passwords. Some of these information fields may be omitted and others added without detracting from the spirit of the invention. In order to increase security, the operator requesting registration at the customer site provides an indication that he (she) is permitted to register the customer with the biller. This may be effected by providing a pre-arranged password at the time of registration, by providing a signed document attesting to this, or by some other means. Once the application for registration is completed at step 303, the application for registration is submitted to the biller entity 104. The registration unit facilitates this communication between the customer entity 102 and the biller entity 104. The application form itself, or the registration unit, contains the necessary routing information to direct the application over the network 106 to the biller computing system 116. At step 308, the biller entity 104 reviews the application for registration to determine whether the customer entity 102 should be permitted to register and whether any information is missing. If registration is denied, for example information is missing, the customer entity is already registered or the operator requesting registration does not have the permission to do so, at step 312 the biller entity 104 returns a message to the customer entity 102 indicating that the application for registration has been denied. Conversely, if the application is granted, the biller entity 104 may return a message indicating that the application for registration is successful.

Assuming that the application for registration is granted, at step 310 the biller computing system 116 at the biller entity 104 creates a customer account entry in the customer database 202 including a customer identifier and a plurality of records. Each record associated to the customer identifier includes an authorized user name and password. A link between the customer account entry in the customer database 202 is associated to an entry in the invoice database 203. In addition, a link between the customer account entry in the customer database 202 is associated to an entry in the dispute history data structure 209. In a specific implementation, the program element further provides functionality for allowing an operator at the consumer entity to modify the entries in the consumer database such as to add/remove authorized user identifiers, modify passwords, modify privileges and so on. Following this, the registered customer may handle invoices over the network 106.

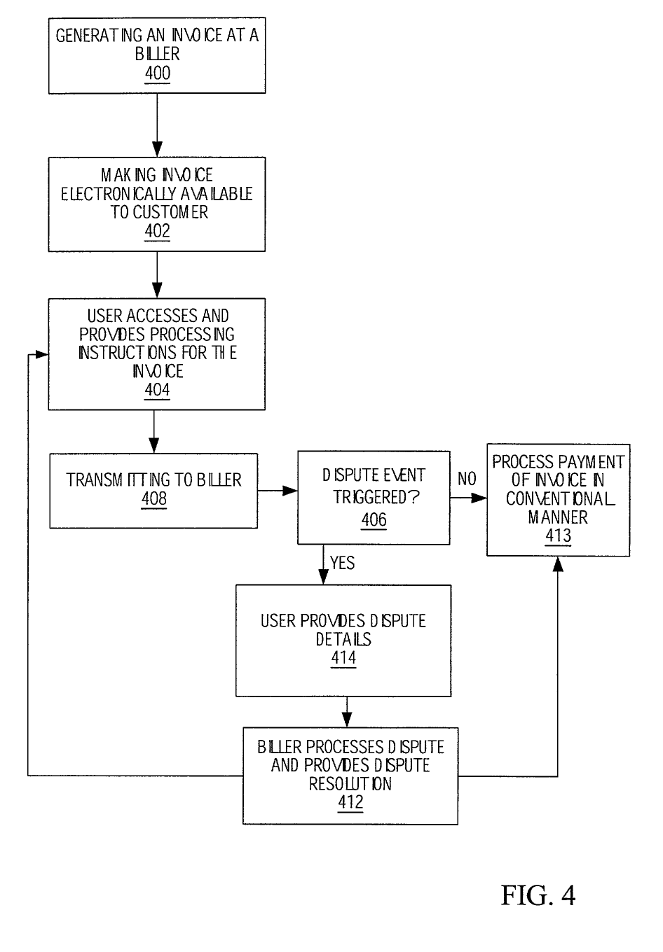

FIG. 4 is a flow diagram of a process for electronic dispute processing and handling in accordance with specific examples of implementation of the invention.

With reference to FIG. 4, at step 400, the biller computing system 116 generates an invoice at the biller entity. The invoice is stored in the invoice database 203 and is associated with a customer account entry in the customer database 202. The status data elements defining the dispute status are also set at this stage. In a non-limiting example, the dispute status data element is indicative of an absence of a dispute event. At step 402, the invoice is made electronically available to the customer entity.

In a first non-limiting example of implementation, the invoice is transmitted via e-mail to an operator at the customer entity. The invoice is provided as a data structure including various fields modifiable by the operator. In a non-limiting example, a field is provided allowing the operator to provide payment remittance information credit card information, an authorization to debit a bank account, wire transfer information, direct deposit information or an indication that a check will be mailed. A field is also provided allowing the operator to dispute the invoice.

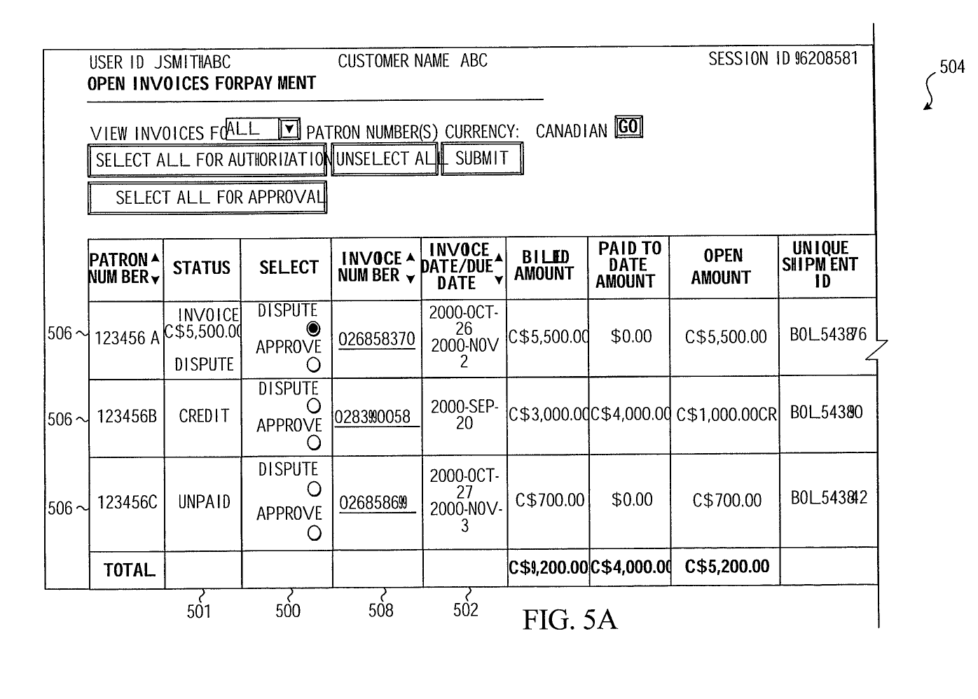

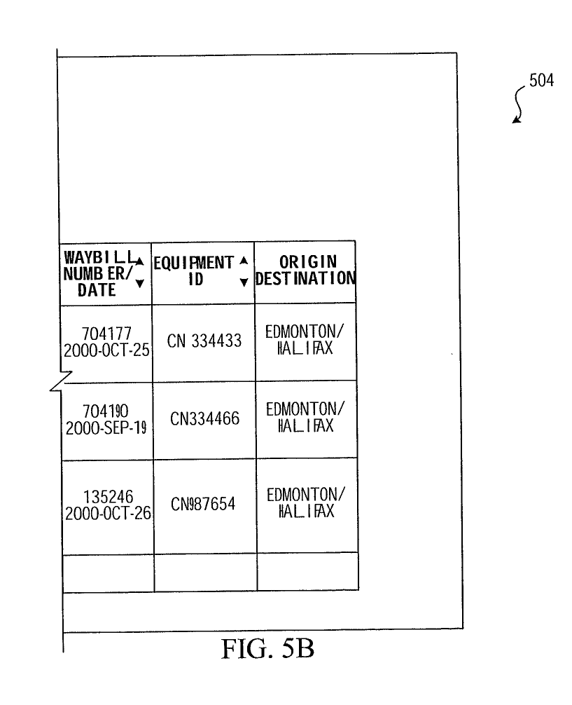

In a second non-limiting example of implementation, the invoice is made electronically available over network 106 by providing a designated website. In a non-limiting example, the website is a secure website implementing an electronic invoice payment system. Authorized operators associated with the customer entity can access the site in order to perform designated tasks. In the second specific example of implementation, the invoice is electronically transmitted over the Internet. In order to view invoices, an operator associated to the customer entity access a designated website through a network link by providing a network address in order to view invoices and other account information. The operator logs on to the secure website by providing login information including a customer identifier, a login name and a password. The biller computing system received the login information and processes it with respect to the customer database 202. More specifically, the processor 208 accesses the customer database 202 to locate the entry corresponding to the customer identifier. If no corresponding entry is found, an error message is returned to the customer entity. If a corresponding entry is found, the processor 208 attempts to locate a record corresponding to the login name provided. If no corresponding record is found, an error message is returned to the operator. If a corresponding record is found, the password in the record is compared to the password provided in the login information. If a match is not found, an error message is returned to the operator. If a match is found, the operator is successfully identified. Once the operator is successfully identified, the account information in the invoice database 203 corresponding to the customer identifier is transmitted to the operator's terminal for display on a graphical user interface at the operator's computer terminal. The graphical user interface provides the operator with the ability to view one or more outstanding invoices associated with the biller entity 104. FIGS. 5a and 5b of the drawings depicts a graphical user interface showing 3 unpaid invoices in a table 504. Each invoice is depicted as a row 506 in the table 504, each invoice being associated to various information data elements describing characteristics of the invoice. In a non-limiting example, the graphical user interface provides a link for accessing an electronic copy of the complete invoice. In the graphical user interface shown in FIGS. 5a and 5b, this is effected by providing a link associated to the invoice number in the invoice number column 508. When activating a link in the invoice number column 508, a corresponding invoice is displayed to the operator at the customer entity site. In a non-limiting implementation, each invoice is provided with a selection column 500 allowing the operator to handle an invoice. The selection column includes a field modifiable by the operator to indicate that that the operator intends to dispute the invoice. Each invoice is also provided with a status column 501 indicating the status of the corresponding invoice. In the table, the status of the first invoice indicates that the invoice is being disputed, the status of the second invoice indicates that the invoice has a credit and the status of the third invoice indicates that the invoice in unpaid.

Continuing the typical interaction, at step 404, the operator obtains access to the account information in the manner described above. Once the operator has viewed a certain invoice he may process the invoice by providing processing instructions to the biller. The processing instructions may include a dispute event trigger data element. In a first example of implementation, the operator enters in column 500 processing instructions for a given invoice by checking a box or filling in a field. In a specific implementation, the graphical user interface is provided with a check box allowing the operator to dispute a certain invoice.

At step 408 the processing instructions are transmitted in a message from the customer computing unit to the biller over the network 106. The biller entity processes the instructions received from the operator. At step 406 the biller determines whether a dispute event trigger is present. If step 406 is answered in the negative, the system proceeds to step 413 where the processing instructions and the invoice payment are processed in a conventional manner. The payment process of the invoice may vary from one implementation to another. A description of the payment process is not necessary for the understanding of the present invention and as such will not be described.

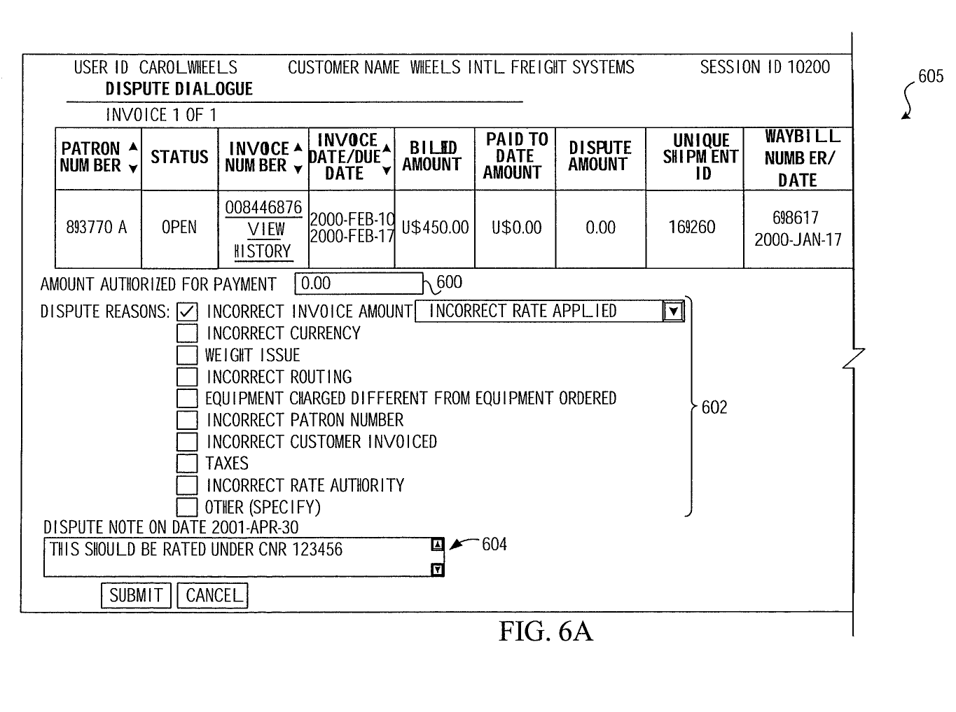

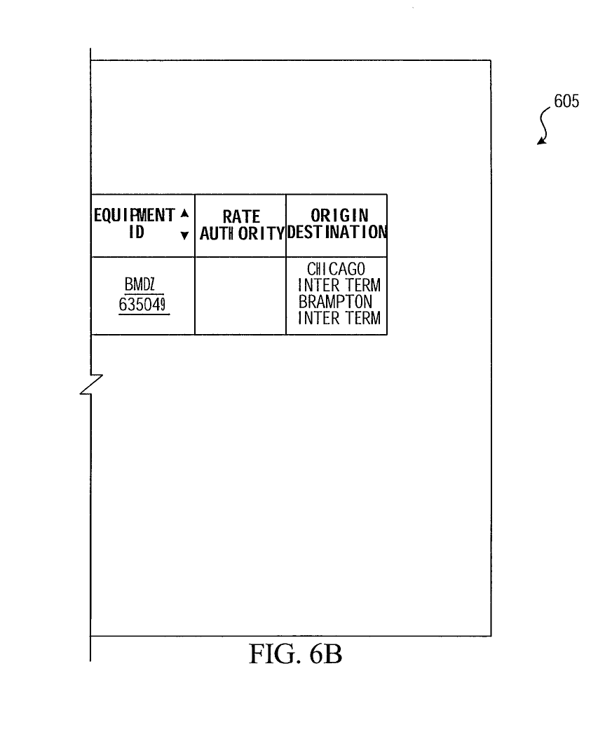

If step 406 is answered in the positive, a dispute event is detected. In a non-limiting example of implementation, at step 414, subsequent to the detection of the dispute event, the biller computing system issues a message to the customer computing unit to launch a dispute resolution unit to aid the operator at the customer computing unit in the description of the dispute. The dispute resolution unit is implemented by program element 204 and provides dispute handling capabilities. More specifically, the dispute resolution unit causes a dispute resolution interface to be generated at the customer computing unit. A specific example of implementation of the dispute resolution interface provided at the customer computing unit is depicted in FIGS. 6a and 6b of the drawings. The dispute resolution interface 605 is a form and an underlying data structure including a plurality of modifiable fields, the fields being suitable for storing dispute reasons. In the dispute resolution interface 605 shown in FIGS. 6a and 6b, fields 600 602 604 are provided allowing the operator to provide a plurality of dispute reasons. Field 600 allows the operator to enter a modified amount that the operator feels is more reasonable for the invoice. Fields 602 allow an operator to select from a list of predetermined dispute reasons, the reason why the invoice is being disputed. The list includes a variety of possibilities and the operator simply selects a box located next to a given reason. Field 604 is a comment box providing an editable field where the operator at the customer computing unit can enter specific comments regarding the invoice in the form of a text message.

Once the dispute resolution form is completed it is submitted to the biller. The submission may be done electronically over the web page, via e-mail or by conventional snail mail without detracting from the spirit of the invention. The customer computing unit transmits the dispute resolution form containing reasons for disputing the invoice in a message over the network 106.

In a specific example of implementation, the dispute resolution unit implemented by the modules of the program elements 204 allows the biller to maintain a historical database of customer disputes and allows the biller to establish a payment/dispute pattern for customers.

In a typical interaction, the dispute resolution unit at the biller computing system 116 is responsive to a message received from the customer computing unit over the network 106 and representative of reasons to dispute an invoice submitted by a given customer entity to locate the group of records in the dispute history data structure 209 corresponding to the customer entity. A new record is created on the basis of the message received. The new record is stored in the dispute history data structure 209. Each time a new dispute is received from a given customer, it is added as a new record in the group of records corresponding to the customer in the dispute history data structure 209. The fields of the new record are also completed at this stage namely the user name, the date and the dispute stage field are completed. In this implementation, the dispute stage field includes a data element indicating that a new dispute has been initiated.

Operators at the biller site can then access this information in order to resolve a new dispute with the customer while allowing the biller to view past disputes in the dispute history data structure 209. This allows the biller to have a more complete view of his relationship with his customer without requiring the customer to re-iterate past issues. In a specific implementation, when the biller receives the dispute from the customer, the dispute resolution unit launches a dispute interface providing the biller with editable fields for entering the dispute results or notes. The group of records in the dispute history data structure associated with the customer are also displayed to the operators at the biller site.

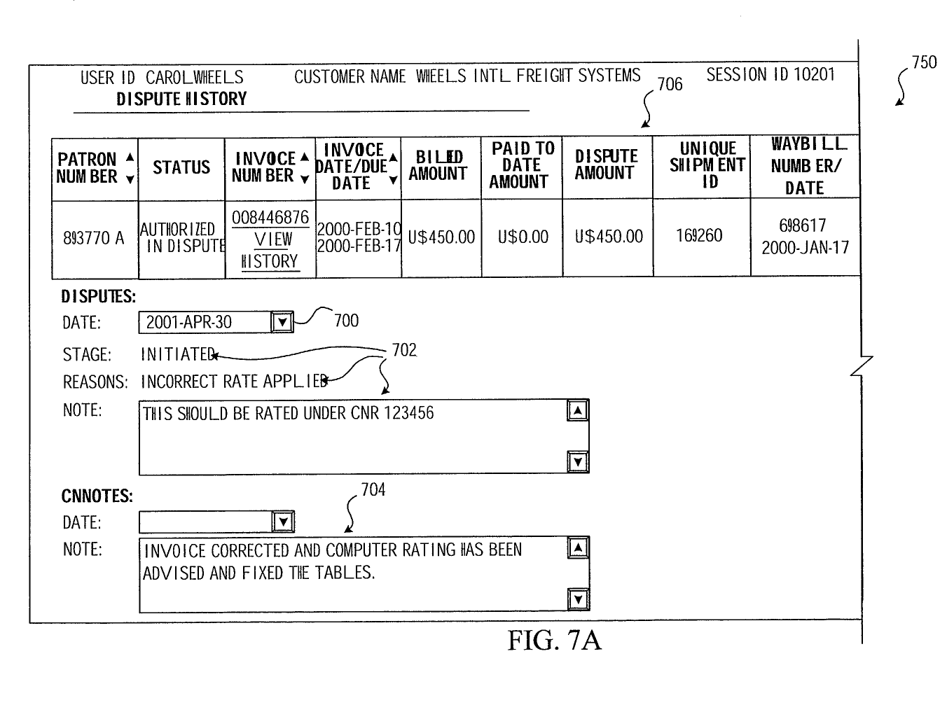

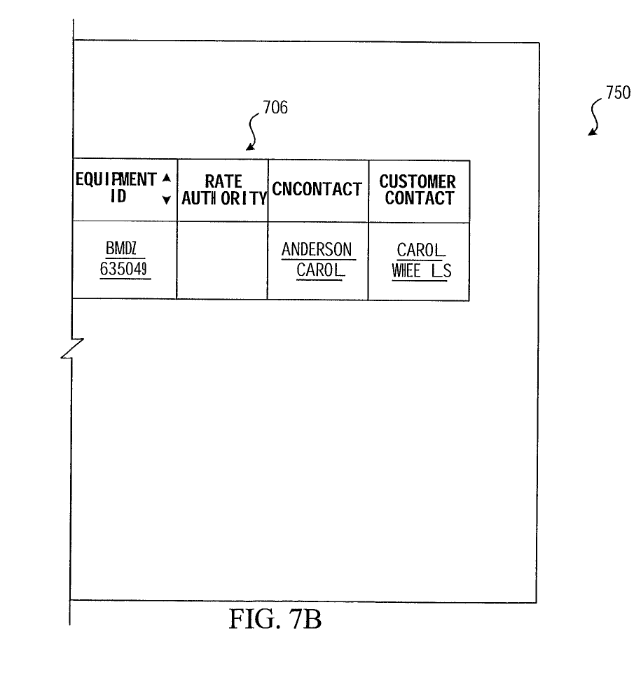

In a non-limiting example, at the biller computing system 116, an operator associated with the biller accesses entries in the dispute history data structure in order to address unresolved disputes. The biller computing system 116 (FIG. 1) further includes a biller computing unit. The biller computing unit is associated to an operator at the biller entity site. The operator may be for example a person responsible for accounts receivables. The dispute resolution unit is operative to issue to the biller computing unit a message to cause the generation at the biller computing unit of a biller dispute resolution interface. A specific example of implementation of the biller dispute resolution interface provided at the biller computing unit is depicted in FIGS. 7a and 7b of the drawings. The dispute resolution interface 750 is a form and an underlying data structure including a plurality of fields. As depicted, the biller dispute resolution interface includes a first field 706 displaying information about the new invoice disputed by the given customer entity.

The biller dispute resolution interface also includes a second field linked to the dispute history data structure associated with the current invoice to display at the biller computing unit the group of records associated with the given customer entity. In the specific implementation, the second field 700 is in the form of a selection list indexed in the basis of the dispute date. To view the dispute history, the operator at the biller site, selects the date of the dispute he wishes to view. The dispute details are then displayed in fields 702 and 704. Although the embodiment depicted in the drawings displays a signal dispute record, embodiments displaying several dispute records or all records in the group of records associated to the customer entity remain within the scope of the invention.

As a variant, the biller dispute resolution interface includes a filter to perform a filtering function on the group of records associated with the given customer entity. In FIG. 7a, the filtering operation is effected on the basis of selection list indexed in the basis of the dispute date in field 700. Other filtering operations may be effected for filtering the records. For example, the filtering may be effected on the basis of the operator name at the customer site having initiated the dispute, the dispute reasons and the dispute stage amongst others. The filtering function is modifiable by the operator at the biller computing unit to specify a filtering function to display only the records in the group of records associated with the given customer entity that match the filtering function.

When an operator associated with the biller wishes to address a dispute submitted by a given customer entity, the biller dispute resolution interface is launched on the biller computing unit associated with the operator. The operator then selects from a list of unprocessed disputes a dispute to be addressed. At step 412, the biller's accounts receivables department then deals with the dispute according to the biller's established procedure. The biller dispute resolution interface includes an editable field 704 in which the operator at the biller computing unit can enter a text string. The text string is generally indicative of comments or notes pertaining to the dispute from the operator as well as an indication of what actions have been taken from the biller's side to address the dispute. Once the operator has finished entering the text string in editable field 704, he submits the text string electronically to the dispute resolution unit. The dispute resolution unit is operative to store in the dispute history data structure the text string entered at the biller computing unit, the text string being stored in association with the record corresponding to the new invoice.

It will be readily apparent that a same invoice may be disputed several times by a customer entity. This is illustrated by the arrow from step 412 to 404 in FIG. 4. Namely, once the operator at the biller computing unit has dealt with the dispute and has inserted his comments, the invoice is accessed by the operator at the customer computing unit at step 404. The operator may choose to pay the invoice or may trigger another dispute event.

In accordance with a non-limiting implementation, an operator at a customer computing unit is provided with access to the dispute history data structure 209 in order to view the status of pending disputes regarding invoices. More specifically, the dispute resolution unit is operative to issue to the customer computing unit a message to cause the generation at the customer computing unit of a dispute resolution interface. For each dispute record associated to the customer entity, the dispute resolution interface includes a first field displaying information about the corresponding invoice and a second field displaying information indicative of text string entered at the biller computing unit. Optionally, the dispute resolution interface also provides the operator at the at a customer computing unit to enter additional comments with regards to the dispute and submit these comments electronically to the biller entity. These additional comments are stored in the dispute history data structure 209 in association with the dispute record corresponding with the invoice being disputed.

The dispute result history for a given customer entity may also be accessed at the biller site when issuing new invoices in order to avoid repeating a same error.

Although the detailed description describes extensively a system for electronically presenting and granting payment of invoices where the invoices are accessible via a web based interface, other embodiments are possible. For example, invoices may be sent to operators at the customer entity via electronic mail, the operators having suitable permission levels for processing the invoices. At the customer site, the operators open the received electronic mail and the account information contained therein is displayed on a graphical user interface on the operators' computer terminals. The handling of the invoice at the biller site may be effected in a similar fashion as that described above.

Although the present invention has been described in considerable detail with reference to certain preferred embodiments thereof, variations and refinements are possible without departing from the spirit of the invention. Therefore, only the appended claims and their equivalents should limit the scope of the invention.

1) A computer readable storage medium containing a program element for execution by a biller computing apparatus residing in a data network for implementing an electronic invoice management system, comprising:
a) an invoice generation unit operative for producing data files representative of invoices issued by a biller to respective customer entities;
b) a dispute resolution unit in communication with a dispute history data structure holding a plurality of groups of records, each record being descriptive of reasons a prior invoice produced by the invoice generation unit was disputed by a customer entity, each group of records being associated to a corresponding customer entity;
c) said dispute resolution unit being responsive to a message received from a first customer computing unit over the data network and representative of reasons to dispute a new invoice submitted by a given customer entity to:
i) locate the group of records in the dispute history data structure corresponding to the given customer entity;
ii) create a record from the message representative of reasons to dispute the new invoice from the given customer entity and store the created record in the dispute history data structure.

2) A computer readable storage medium as defined in claim 1, wherein said dispute resolution unit is operative to issue a message to the first customer computing unit to cause generation at the first customer computing unit a dispute resolution interface.

3) A computer readable storage medium as defined in claim 2, wherein said dispute resolution interface has a plurality of predetermined choices that an operator at the first customer computing unit can select, each choice being a predetermined reason to dispute an invoice.

4) A computer readable storage medium as defined in claim 3, wherein said dispute resolution interface has an editable field in which the operator at the first customer computing unit can enter a text message.

5) A computer readable storage medium as defined in claim 2, wherein said dispute resolution unit is operative to issue to a second customer computing unit a message to cause the generation at the second customer computing unit of a dispute resolution interface, the second computing unit being associated to an operator of the given customer entity.

6) A computer readable storage medium as defined in claim 5, wherein said dispute resolution interface includes a field displaying information about the new invoice disputed by the given customer entity.

7) A computer readable storage medium as defined in claim 2, wherein said dispute resolution unit is operative to issue to a biller computing unit a message to cause the generation at the biller computing unit of a biller dispute resolution interface, the biller computing unit being associated to an operator of the biller.

8) A computer readable storage medium as defined in claim 7, wherein said biller dispute resolution interface includes a field displaying information about the new invoice disputed by the given customer entity.

9) A computer readable storage medium as defined in claim 8, wherein said biller dispute resolution interface includes a field linked to said dispute history data structure to display the group of records associated with the given customer entity.

10) A computer readable storage medium as defined in claim 9, wherein said biller dispute resolution interface includes a filter to perform a filtering function on the group of records associated with the given customer entity.

11) A computer readable storage medium as defined in claim 10, wherein said filter is modifiable allowing an operator at the biller computing unit to specify a filtering function to display only the records in the group of records associated with the given customer entity that match the filtering function.

12) A computer readable storage medium as defined in claim 11, wherein said biller dispute resolution interface includes an editable field in which the operator at the biller computing unit can enter a text string.

13) A computer readable storage medium as defined in claim 12, wherein said dispute resolution unit is operative to store in the dispute history data structure the text string entered at the biller computing unit, the text string being stored in association with the record corresponding to the new invoice.

14) A computer readable storage medium as defined in claim 13, wherein said dispute resolution unit is operative to issue to a customer computing unit a message to cause the generation at the customer computing unit of a dispute resolution interface, the computing unit being associated to an operator of the given customer entity, said dispute resolution interface including:
a) a first field displaying information about the new invoice disputed by the given customer entity;
b) a second field displaying information indicative of the text string entered at the biller computing unit.

15) An electronic invoice management system, comprising:
a) a biller machine;
b) a customer computing unit;
c) a data network interconnecting said biller machine to said customer computing unit;
d) said biller machine including:
i) an invoice generation unit operative for producing data files representative of invoices issued by a biller to respective customer entities;
ii) a dispute resolution unit in communication with a dispute history data structure holding a plurality of groups of records, each record being descriptive of reasons a prior invoice produced by the invoice generation unit was disputed by a customer entity, each group of records being associated to a corresponding customer entity;
iii) said dispute resolution unit being responsive to a message received from said customer computing unit over said data network and representative of reasons to dispute an invoice submitted by a given customer entity to:
(1) locate the group of records in the dispute history data structure corresponding to the given customer entity;
(2) create a record from the message representative of reasons to dispute an invoice from the given customer entity and store the created record in the dispute history data structure.

16) A system as defined in claim 15, wherein said dispute resolution unit is operative to issue a message to said customer computing unit to cause generation at said customer computing unit a dispute resolution interface.

17) A system as defined in claim 16, wherein said dispute resolution interface has a plurality of predetermined choices that an operator at said customer computing unit can select, each choice being a predetermined reason to dispute an invoice.

18) A system as defined in claim 17, wherein said dispute resolution interface has an editable field in which the operator at said customer computing unit can enter a text message.

19) A system as defined in claim 16, said system further comprising a biller computing unit operatively connected to said biller machine, said dispute resolution unit being operative to issue to said biller computing unit a message to cause the generation at said biller computing unit of a biller dispute resolution interface.

20) A system as defined in claim 19, wherein said biller dispute resolution interface includes a field displaying information about the new invoice disputed by the given customer entity.

21) A system as defined in claim 20, wherein said biller dispute resolution interface includes a field linked to said dispute history data structure to display at said biller computing unit the group of records associated with the given customer entity.

22) A system as defined in claim 21, wherein said biller dispute resolution interface includes a filter to perform a filtering function on the group of records associated with the given customer entity.

23) A system as defined in claim 22, wherein said filter is modifiable allowing an operator at the biller computing unit to specify a filtering function to display only the records in the group of records associated with the given customer entity that match the filtering function.

24) A system as defined in claim 23, wherein said biller dispute resolution interface includes an editable field in which the operator at the biller computing unit can enter a text string.

25) A system as defined in claim 24, wherein said dispute resolution unit is operative to store in the dispute history data structure the text string entered at the biller computing unit, the text string being stored in association with the record corresponding to the new invoice.

26) A system as defined in claim 25, wherein said dispute resolution unit is operative to issue to said customer computing unit a message to cause the generation at said customer computing unit of a dispute resolution interface, said dispute resolution interface including:
a) a first field displaying information about the new invoice disputed by the given customer entity;
b) a second field displaying information indicative of the text string entered at the biller computing unit.

27) A method for electronic invoice management comprising:
a) generating at a biller machine data files representative of invoices issued by a biller to respective customer entities;
b) providing a data structure holding a plurality of groups of records, each record being descriptive of reasons a prior invoice generated at the biller machine was disputed by a customer entity, each group of records being associated to a corresponding customer entity;
c) in response to a message to the biller machine issued by a customer computing unit and representative of reasons to dispute an invoice submitted by a given customer entity:
i) locating in the data structure the group of records corresponding to the given customer entity;
ii) creating a record from the message representative of reasons to dispute an invoice from the given customer entity and storing the created record in the dispute history data structure.

28) A method as defined in claim 27, said method further comprising issuing a message to the customer computing unit to cause generation at the customer computing unit of a dispute resolution interface.

29) A method as defined in claim 28, wherein said dispute resolution interface has a plurality of predetermined choices that an operator at the customer computing unit can select, each choice being a predetermined reason to dispute an invoice.

30) A method as defined in claim 29, wherein said dispute resolution interface has an editable field in which the operator at the customer computing unit can enter a text message.

31) A method as defined in claim 28, said method further comprising issuing to a biller computing unit a message to cause the generation at the biller computing unit of a biller dispute resolution interface, the biller computing unit being associated to an operator of the biller.

32) A method as defined in claim 31, wherein said biller dispute resolution interface includes a field displaying information about the new invoice disputed by the given customer entity.

33) A method as defined in claim 32, wherein said biller dispute resolution interface includes a field linked to said dispute history data structure to display the group of records associated with the given customer entity.

34) A method as defined in claim 33, wherein said biller dispute resolution interface includes a filter to perform a filtering function on the group of records associated with the given customer entity.

35) A method as defined in claim 34, wherein said filter is modifiable allowing an operator at the biller computing unit to specify a filtering function to display only the records in the group of records associated with the given customer entity that match the filtering function.

36) A method as defined in claim 35, wherein said biller dispute resolution interface includes an editable field in which the operator at the biller computing unit can enter a text string.

37) A method as defined in claim 36, said method comprising storing in the dispute history data structure the text string entered at the biller computing unit in association with the record corresponding to the new invoice.

38) A method as defined in claim 37, said method further comprising issuing to a customer computing unit a message to cause the generation at the customer computing unit of a dispute resolution interface, said dispute resolution interface including:
a) a first field displaying information about the new invoice disputed by the given customer entity;
b) a second field displaying information indicative of the text string entered at the biller computing unit.

39) An electronic invoice management system comprising:
a) means for producing data files representative of invoices issued by a biller to respective customer entities;
b) dispute handling means in communication with a dispute history data structure holding a plurality of groups of records, each record being descriptive of reasons a prior invoice produced by the means for producing was disputed by a customer entity, each group of records being associated to a corresponding customer entity;
c) said dispute handling means being responsive to a message received from a first customer computing unit over the data network and representative of reasons to dispute a new invoice submitted by a given customer entity to:
i) locate the group of records in the dispute history data structure corresponding to the given customer entity;
ii) create a record from the message representative of reasons to dispute the new invoice from the given customer entity and store the created record in the dispute history data structure.
